(19) United States
(12) Patent Application Publication
(10) Pub. No.: US 2002/0115344 A1
(43) Pub. Date: Aug. 22, 2002

(54) Mobile phone connector

(76) Inventor: Wen-Chin Chen, Shulin City (TW)

Correspondence Address: Keith Kline, PRO-TECHTOR INTERNATIONAL SERVICES, 20775 Norada Court, Saratoga, CA, 95070-3018, US

(21) Appl. No.: 09/747,837

(22) Filed: Dec. 27, 2000

(51) Int. Cl. H01R 13/40

(52) U.S. Cl. 439/587

(57) ABSTRACT

This invention provides a connector construction, a connector to be fitted to a mobile phone. The connector comprises an insulating casing that has a welded side and a matching side, a terminal accommodating chamber on the insulating casing, a conductive terminal that has a welded part and a matching part inside the accommodating chamber, and an anti-leak packing fitted to the outside rim of the matching side of the insulating casing; such characteristics are designed that, when the connector is welded to the main board of a mobile phone and assembled as one unit, the anti-leak packing obstructing between the connector and the housing of the mobile phone, aided by the obstruction performance provided by the matching part and welded part of the monobloc formed conductive terminal, will prevent the mobile phone from water seepage.

### BACKGROUND OF THE INVENTION

1. Field of the Invention

This invention relates to a connector construction, particularly a connector construction providing water-resistant effect when it is assembled to a mobile phone.

2. Background of the Invention

All functions of conventional mobile phones, regardless of communication, charging, exterior facsimile or Internet surfing, are provided by the main board installed inside the phone set, while part of the signal transmission done by the main board must be performed by a connector. Therefore, the connector and the main board are closely related. In the conventional type of assembly of connector and mobile phone, there is no design for water resistance, so it is not unusual that the problem of inconsistent signal transmission may occur when the mobile phone is used in a humid environment. The reason lies in the fact that moisture may seep through the conductive terminal of the connector or the seam between the connector and the mobile phone housing, which results in poor signal transmission. Therefore, how to design a connector that will be water-resistant when it is assembled to a mobile phone, has become an essential task.

### BRIEF DESCRIPTION OF THE INVENTION

1. Objective of the Invention

The objective of this invention is to provide a connector that is water-resistant after it is fitted to a mobile phone, a design that allows no communication between the matching side and welded side after the connector is fitted to a mobile phone. The mobile phone shall be hermetically assembled, to ensure no water seepage, freedom of bad influence to the normal performance of the main board, and consistent communication quality, when the mobile phone is in use.

2. Characteristics of the Invention

The invention relates to a connector to be fitted to a mobile phone, the connector comprising an insulating casing that has a welded side and a matching side, a terminal accommodating chamber on the insulating casing, a conductive terminal having a welded part and a matching part and monobloc formed inside the accommodating chamber, and tightening holes located next to the terminal accommodating chamber, the tightening holes being opened on the matching side of the insulating casing, without communication with the welded side, and an anti-leak packing fitted to the outside rim of the matching side of the insulating casing; with such characteristics, when the connector is welded to the main board of the mobile phone and assembled as one unit, the anti-leak packing obstructing between the connector and the housing of the mobile phone, aided by the obstruction performance provided by the matching part and welded part of the monobloc formed conductive terminal, will prevent the mobile phone from water seepage.

### BRIEF DESCRIPTION OF DRAWINGS

The drawings of preferred embodiments of this invention are described in following details to enable better understanding.

FIG. 1 is a perspective, disassembled view of this invention.

FIG. 2 is a perspective, assembled view of this invention.

FIG. 3 is a section view of FIG. 2 taken from the line A-A.

FIG. 4 is a perspective view of this invention before it is fitted to a mobile phone.

FIG. 5 is a perspective view of this invention after it is fitted to a mobile phone.

BRIEF DESCRIPTION OF NUMERALS

| | | | |
|---|---|---|---|
| 1 | connector | 10 | insulating casing |
| 101 | welded side | 102 | matching side |
| 11 | terminal accommodating | 110 | accommodating groove |
| | chamber | | |
| 12 | tightening hole | 13 | fixing hole |
| 14 | fastening plate | 20 | conductive terminal |
| 201 | matching part | 202 | welded part |
| 30 | anti-leak packing | 5 | mobile phone |
| 50 | upper casing | 51 | lower casing |
| 52 | assembling groove | 60 | anti-leak packing |

### DETAILED DESCRIPTION OF PREFERRED EMBODIMENTS

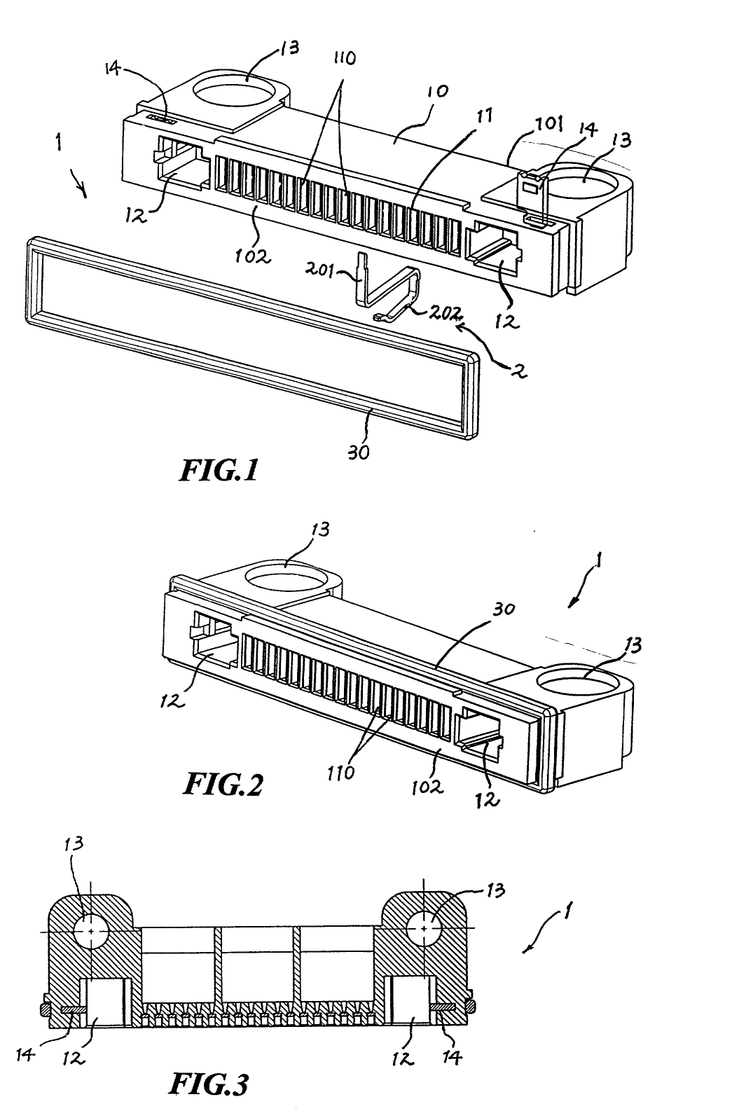

As shown in FIGS. 1 and 2, this invention of connector 1 comprises an insulating casing 10, a conductive terminal 20, and an anti-leak packing 30. The insulating casing 10 is an elongated body having a welded side 101 that is welded to the main board (not shown in drawing) of a mobile phone, and a matching side 102 that matches with a matching connector for transmission of electronic signals. At approximately the center of the insulating casing 10 is a terminal accommodating chamber 11, serving to accommodate the conductive terminal 20. The terminal accommodating chamber 11 has a plurality of accommodating groves 110, which are arranged in vertical alignment at the matching side 102 of the insulating casing 10. As shown in FIG. 3, next to the left and right sides of the terminal accommodating chamber 11 are tightening holes 12 that serve to fasten the insulating casing 10 to the matching connector. The tightening holes 12 are opened on the matching side 102 of the insulating casing 10, without communication wish the welded side 101, and on its two sides are fastening plates 14. On the outside of the matching side 102 of the insulating casing 10 is a depressed groove 13 that serves to accommodate the anti-leak packing 30. On the left and right sides of the welded side of the insulating casing 10 are fixing holes 13, which can be fitted to the housing of a mobile phone.

The conductive terminal 20 is monobloc formed inside the terminal accommodating chamber 11, having a matching part 201 and a welded part 202. The matching part 201 is an erective plate that can match one of the erective accommodating grooves 110 in the assembly. The welded part 202 is an extension of the matching part 201 that is bent three folds to become parallel to the main board of the mobile phone, for surface adhesion and welding process.

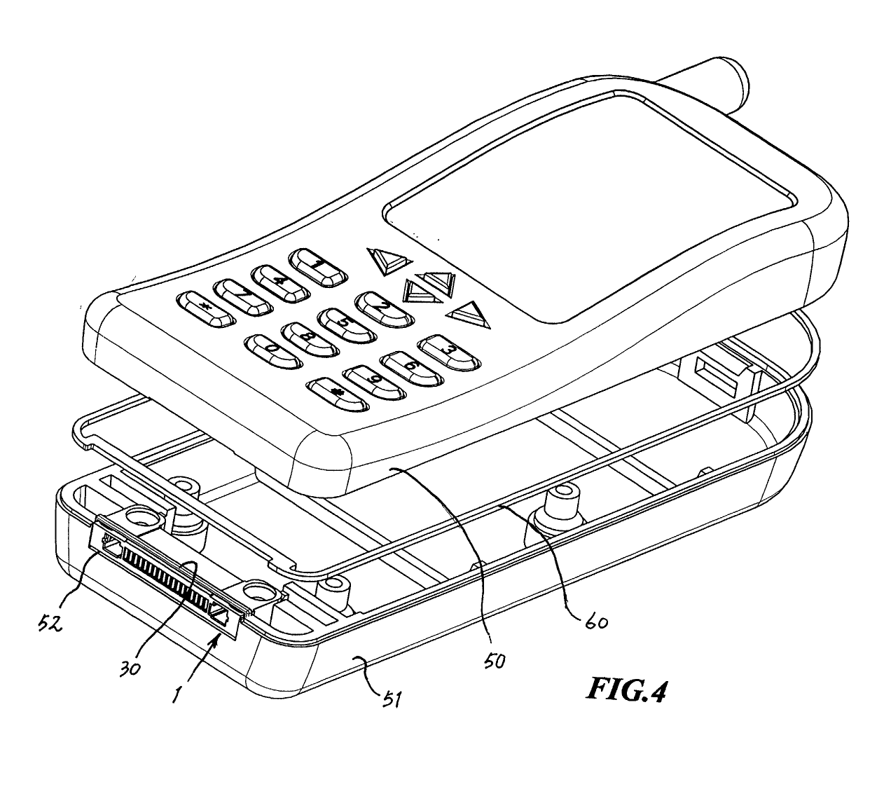

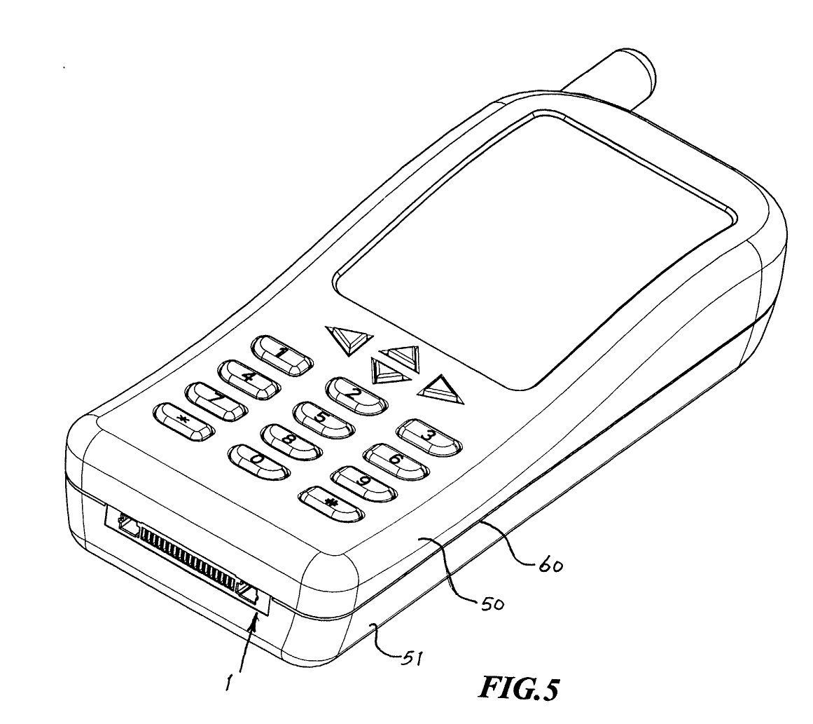

As shown in FIGS. 4 and 5, which illustrate the preferred embodiment of this invention of connector to be fitted to a mobile phone 5, the anti-leak packing 30 is fitted to the assembling groove 52 between the upper and lower casings 50, 51 of the mobile phone 5, and, between the rims of the upper and lower casings 50, 51 is also an anti-leak packing 60. Therefore, both the seams between the upper and lower casings 50, 51 and between the connector 1 and the assembling groove 52 are water-resistant. Since the matching part 201 and the welded part 202 of the conductive terminal 20 are not communicative, and nor are the tightening hole 12 and the welded side 101, there will be no water seeping through the assembled side of the connector 1. Freedom from water seepage ensures steady transmission of signals when the mobile phone is in use.

As evidenced in the above description, this invention is capable of achieving its anticipated objective. However, the above description covers only the preferred embodiment of this invention. All modifications and variations deriving from this invention shall be included in the claim of this patent.

What is claimed is:

1. A connector, particularly a connector to be fitted to a mobile phone, the connector comprising:
An insulating casing that has a welded side and a matching side, on which being a terminal accommodating chamber, and on two sides of the terminal accommodating chamber being tightening holes, said tightening holes being opened on the matching side of the insulating casing, and not communicative with the welded side;
A conductive terminal that is monobloc formed inside the terminal accommodating chamber, having a welded part and a matching part; and An anti-leak packing that is fitted to the outside rim of the matching side of the insulating casing;
with such a construction, when the connector is welded to the main board of a mobile phone and assembled as one unit, the anti-leak packing obstructing the connector from the housing of the mobile phone will enable the mobile phone to resist water.

2. The connector as claimed in claim 1, wherein said terminal accommodating chamber has a plurality of accommodating grooves, the sides of said accommodating grooves located on the matching side of the insulating casing being arranged in vertical alignment.

3. The connector as claimed in claim 2, wherein the matching part of said conductive terminal is an erective plate, while its welded part is an extension from the matching part that is bent in three folds to become parallel to the main board of the mobile phone, to facilitate surface adhesion and welding.

4. The connector as claimed in claim 3, wherein on the outside rim of the matching side of said insulating casing is a depressed groove to accommodate the anti-leak packing.

5. The connector as claimed in claim 4, wherein on the insulating casing and opposite the tightening holes are fastening plates, said fastening plates have fastening parts located in the tightening holes.

6. The connector as claimed in claim 5, wherein on the left and right sides of the welded side of the insulating casing are fixing holes, which are used for fixing the insulating casing to the housing of the mobile phone.
